(19) United States
(12) Patent Application Publication
(10) Pub. No.: US 2008/0004966 A1
(43) Pub. Date: Jan. 3, 2008

(54) System and method for control and monitor of sales transactions

(76) Inventors: Shaun W. Singleton, Brisbane (AU); Rachel E. Saunders, Brisbane (AU)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 11/478,528

(22) Filed: Jun. 30, 2006

(51) Int. Cl. G06Q 20/00

(52) U.S. Cl. 705/21

(57) ABSTRACT

A system and method for monitoring and controlling the sale of products to customers is disclosed. The system may include a database for storing the information necessary to control and monitor the sale of products. The system may also include one or more user interfaces for interacting with the database, including a merchant user interface, a law enforcement user interface, a healthcare regulator user interface, and/or an administrator user interface. The user interfaces may be any combination of hardware and software that enable the user to submit information to, and view information from, the database in conformance with the user's access privileges.

### TECHNICAL FIELD

The present disclosure relates generally to systems and methods for controlling and monitoring sales transactions. More specifically, the present disclosure relates to systems and methods for controlling and monitoring sales transactions of regulated products.

### BACKGROUND

It is often desirable to follow or control the sale of certain products in commerce. For example, many commonly available chemicals, such as over-the-counter (OTC) drugs and agricultural chemicals, such as fertilizers, have unfortunately been found useful for non-intended uses or in the preparation of illegal products by some segments of society.

For example, the diversion of pseudoephedrine from common Cough and Cold preparations for use in the manufacture of Methamphetamines or “Speed” has become an enormous problem worldwide. The similarity in chemical structure to amphetamines has made pseudoephedrine a sought-after chemical precursor in the illicit manufacture of methamphetamine and methcathinone. United States federal law places amount and duration limitations on buying cold medications containing pseudoephedrine. Individual states also may have varying laws on the matter. Various other legislatures around the world similarly restrict the sale of pseudoephedrine-containing products. Internationally, pseudoephedrine is listed as a Table I precursor under the United Nations Convention Against Illicit Traffic in Narcotic Drugs and Psychotropic Substances.

Despite legislation that demands the presentation of photo ID and the recording of details, there is no means of effectively sharing this information or quickly acting on this information to prevent illegal or undesirable conduct. A “pseudo runner,” for example, can move from store to store to purchase excessive amount of products containing pseudoephedrine with little fear of detection.

What is needed therefore is a system and method for controlling or monitoring the sale of products, in particular, controlling or monitoring the sale of regulated products such as over-the-counter medications, certain agricultural products (e.g., fertilizer), and firearms.

### SUMMARY OF THE INVENTION

The present disclosure provides a system and method for monitoring and controlling the sale of products to customers. The system includes a database for storing the information necessary to control and monitor the sale of products including, but not limited to: a list of products to be monitored; the predefined amounts of product and time periods within which the product may or may not be purchased; access privileges and policies for various users of the system (including merchants, law enforcement personnel, healthcare regulator personnel, and system administrators); information about customers who have purchased products; and/or information pertaining to transactions involving the sale of products that are controlled and monitored by the system (including date, name of product, quantity of product, location of transaction, identity of merchant, etc.).

One or more user interfaces may be provided for interacting with the database of the present system and method, including a merchant user interface, a law enforcement user interface, a healthcare regulator user interface, and/or an administrator user interface. The user interfaces may be any combination of hardware and software that enable the user to submit information to, and view information from, the database in conformance with the user's access privileges. The merchant user interface, among other capabilities, may allow a merchant to make inquiries and review information to enable the merchant to make a determination whether to allow a sale to proceed, as well as to enter information pertaining to a transaction related to a product.

The law enforcement and healthcare regulator user interfaces, among other capabilities, allow the user to (1) query information contained in the system to determine whether applicable laws, regulations and/or policies are followed by merchants, (2) review transactional information pertaining to a particular product, merchant and/or customer, (3) set alerts and notifications, and/or (4) update or modify information with respect to products to be monitored and update or modify the predefined quantities and time periods within which a product may or may not be purchased. This section of the system can also be used to analyse trends. Meth cooks are always looking for new ‘recipes’. As say supply of solid form tablets is tightened they may start targeting Gel Caps. The system and method of the present disclosure may be used to identify these shifts early.

The administrative user interface, among other capabilities, allows an administrator to maintain the system (including updating or modifying the contents of the database) and alter the look and feel of the various user interfaces.

### BRIEF DESCRIPTION OF THE DRAWINGS

FIG. 1 is a schematic representation of one embodiment of the system of the present disclosure.

FIG. 2 is a flowchart of one embodiment of a method of the present disclosure.

FIG. 3 is a block diagram of an exemplary input screen of the merchant interface for inputting the ID number of a customer.

FIG. 4 is a block diagram of an exemplary input screen of the merchant user interface when the database indicates that no match was found.

FIG. 5 is a block diagram of an exemplary input screen of the merchant user interface showing the transactions associated with a particular ID number.

FIG. 6 is a block diagram of an exemplary input screen of the merchant user interface for entering product information.

FIG. 7 is a block diagram of an exemplary input screen of the merchant user interface showing a summary of transactions.

FIG. 8 is a block diagram of an exemplary screen of the merchant user interface requiring information from the merchant.

### DETAILED DESCRIPTION

The present disclosure provides systems and methods for controlling or monitoring the sale or potential sale of products in commerce. The products may be sold by any merchant including, but not limited to, a wholesaler, retailer, distributor, and the like. The sales or potential sales may be controlled or monitored by any appropriate person or entity, such as a law enforcement agency, a healthcare regulatory agency, or a trade group or trade association.

The product(s) monitored or tracked may be regulated product(s). Regulated products may include (but are not limited to) any commercially available product for which the quantity of the product a consumer may purchase is limited or controlled by an applicable government law or regulation, such as an over-the-counter or prescription pharmaceutical product. Regulated products may also include (but are not limited to) products for which a purchaser may be required to provide legal identification (such as a driver's license or other governmental issued identification) prior to the sale of the product. Regulated products may also include any product for which a background check of a prospective purchaser is required before the sale of the product can be completed, such as a firearm or certain agricultural products.

A regulated product may be a controlled substance including, but not limited to, a chemical listed in 21 C.F.R. §1310.02(a) (which is incorporated herein by reference), also referred to herein as “List I chemicals.”

Several aspects of the embodiments described herein will be illustrated as software programs or components stored in a computing device. As used herein, a software program or component may include any type of computer instruction or computer executable code located within a memory device and/or transmitted as electronic signals over a system bus or network. A software program may, for instance, comprise one or more physical or logical blocks of computer instructions, which may be organized as a routine, program, object, component, data structure, etc., that performs one or more tasks or implements particular abstract data types.

In certain embodiments, a particular software program may comprise disparate instructions stored in different locations of a memory device, which together implement the described functionality of the program. Indeed, a program may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software programs may be located in local and/or remote memory storage devices.

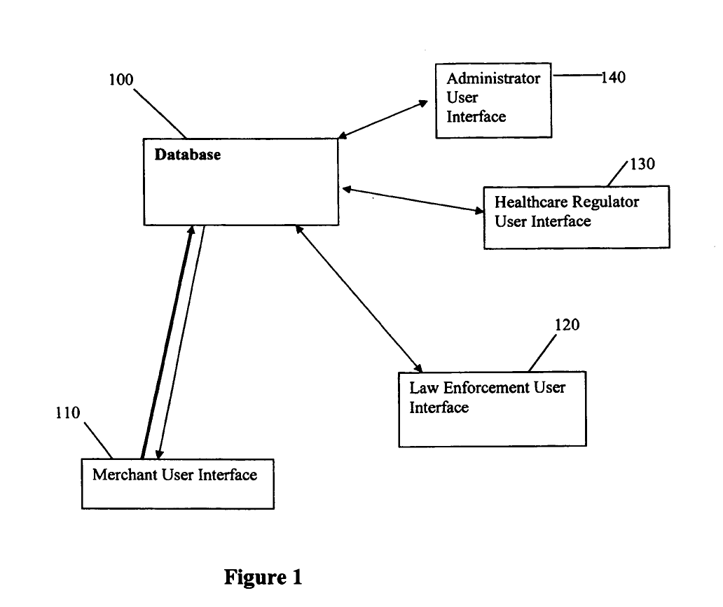

Referring now to FIG. 1, in one embodiment the disclosure provides a system for monitoring the sale of a regulated product comprising a database 100 for storing information pertaining at least to one product, names of merchants within a network, and information pertaining to sales transactions from the merchants. The system may also comprise one or more user interfaces including, but not limited to, one or more merchant user interfaces 110 for allowing merchants to interface with the system, one or more law enforcement user interfaces 120 for allowing law enforcement personnel to interface with the system, one or more healthcare regulator interfaces 130 for allowing healthcare regulator personnel to interface with the system, and one ore more administrator user interfaces 140 for allowing system administrators to interface with the system. The various components of the system (e.g., 100, 110, 120, 130 and 140) may communicate with one another by any appropriate means including, including though a wired or wireless network (e.g., a LAN, WAN, telephone lines, the Internet, etc.).

The user interfaces 110 through 140 may be any computing device (or combination of a device and software) capable of interfacing with the database 100 including, but not limited to, a computer terminal, a barcode reader, a telephone, a personal digital assistant, an electronic signature reader, a scanner, a facsimile machine, webservice component or combinations thereof. A merchant user, a law enforcement user, a healthcare regulator user or an administrator user may gain access to the database through the appropriate user interface by using an appropriate procedure to uniquely and securely identify the user (e.g., by entering a unique combination of username and password). The user interfaces may have any look or feel appropriate for the task of allowing a user to submit information to, and receive information from, the database 100 in conformance with the user's access privileges. The user interfaces may be implemented using dedicated application programs, or may be implemented as a web-based interface which may be accessed and utilized through a conventional web browser software running on a computer. As another alternative, the merchant user interface 110 may be implemented by, or incorporated into, an inventory control software application or a pharmaceutical dispensing software application typically used in pharmacies with the added functionality of being capable of communicating with the database 100 and presenting the information received from the database 100 to a user (e.g., a merchant).

The database 100 includes the information stored therein when the system is first implemented, as well as the information that is provided to it by the various users of the system (e.g., merchants, law enforcement or healthcare regulator personnel) after the system is operational. This information includes, but is not limited to: access privileges for users or devices that can access or communicate with the database (e.g., login IDs, passwords, any conditions or limitations placed on the user's or device's access to the information contained in the database, etc.); name, address, contact information and/or other identifying information of the various users of the system (e.g., merchants, law enforcement or health regulator agencies, etc.); names and possibly other information about the products to be controlled or monitored through use of the system; records of all transactions occurring in the network or geographic area of the system; quantity and/or duration limitations that are placed on the sale of products to be controlled or monitored; the information about a potential or actual customer that may be collected for each potential or actual sale (e.g., name, address, ID information, other physical identification characteristics, name of product, quantity of product, signature, etc.); the geospatial coordinates for the various users of the system (e.g., geospatial coordinates of a merchant's place of business). It is to be understood that a transaction occurring in the system may include, but is not limited to, an actual sale or a potential sale which is not finalized into an actual sale.

Many different database applications exist and may be used in conjunction with the appropriate computer hardware to implement the database 100, including but not limited to relational databases (e.g., Microsoft SQL Server). Although the database 100 is illustrated as a single database in FIG. 1 and referred to in the singular in the discussion herein, it is to be understood that the information stored in the database and the functionalities performed by the database may be spread among one or more database programs on one or more computing devices.

The various user interfaces permit a user to enter information into the database and review information contained in the database based on their access privileges and the policies of the database and the system. For example, a merchant may use a merchant user interface 110 to obtain and review information pertaining to a proposed sale including, but not limited to, whether a customer has recently purchased the same regulated product at another merchant which is part of the system.

Any authorized user at the merchant may use the interface to submit information to the database or to review information contained in the database. Authorized access to the interface (and the system) may be regulated and ensured by any appropriate method including, but not limited to, the use of user names, passwords, biometric information, etc. In one embodiment, an authorized user of the merchant user interface 110 may first access the system by following the appropriate security measures and then request that the customer directly type in or otherwise provide the required customer information (e.g., name, ID information, signature). In another embodiment, the merchant user interface 110 may also include a dedicated input device (e.g., keyboard, scanner, touchpad, etc.) which allows a customer to enter the required customer information but does not otherwise permit the customer to view or gain access to any information otherwise accessible to an authorized user at the merchant.

It is to be understood that because of applicable privacy laws or other reasons, the information that is available to the merchant for review may be a subset of the information that is contained in the database 100. As one illustrative example, even though a merchant or customer may be required to enter the name, ID number, address and gender information of a customer at the time of a transaction, the merchant may be able to review historical transaction data by ID number only and not have access to the name, address or gender associated with that ID number.

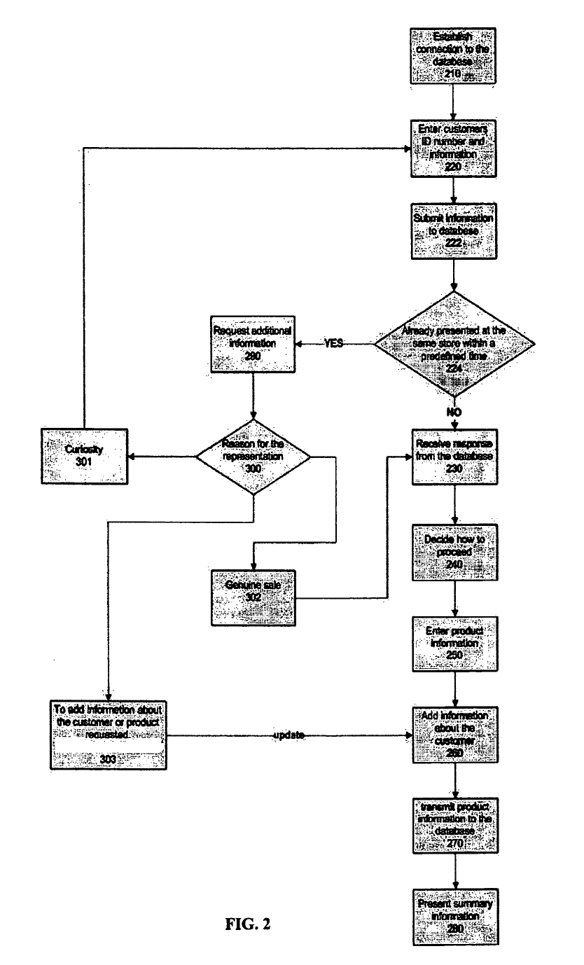

FIG. 2 provides a flow diagram of an exemplary method of operation of the system using the merchant user interface 110. For the purpose of this discussion, and not as a limitation on the scope of the invention, it is assumed that the transaction pertains to the sale of an over the counter pharmaceutical product containing pseudoephedrine and that a pharmacist or pharmacy staff member is using the merchant user interface 110. It is to be understood that the systems and methods discusses herein may be used with respect to any type of merchant and the sale of any type of product. Any modifications or alternations to the system and method described herein to use it for other types of merchants and products are readily apparent to those with skill in the art and may be made without departing from the spirit or scope of the disclosure.

At step 210, a pharmacist or pharmacy staff member may use a computer to establish a network connection with, and may use a unique username and password to gain access to, the database 100. In one embodiment, the system and method of the present disclosure may be implemented as a web-based and web-accessible system and method. In such an embodiment, the pharmacist may open a web browsing application, enter an appropriate internet address to establish a network connection with the database, and then enter the appropriate username and password to gain access to the contents of the database 100. Alternatively, a constant network connection between the user interface 110 and database 120 may exist such that the pharmacist need not establish a new connection every time he or she interacts with the database through the system. In the web-based embodiment, for example, the user may access the appropriate web site at the start of the business day and remain “logged-on” to the system all day. It is to be noted that for security purposes, however, it may be desirable (but not necessary) to log a user out of the system after a certain duration of inactivity.

The pharmacist or pharmacy staff member may request a government issued form of photographic identification, such as a drivers license or ID card from the customer. At step 220, the pharmacist or staff member uses the interface 110 to enter and submit to the database the information about the prospective customer that is required by the system (e.g., ID type, ID number and issuing authority).

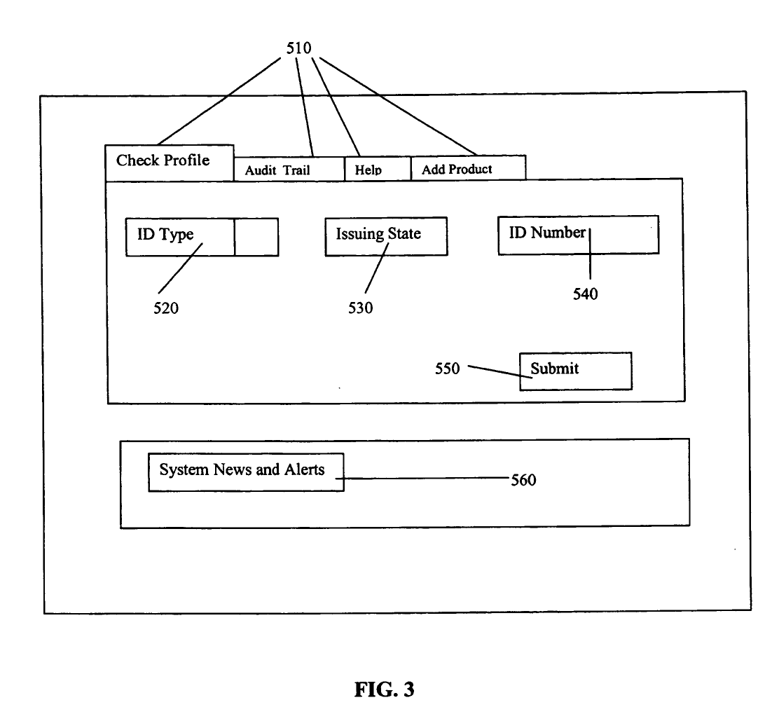

When the pharmacist or pharmacy staff member logs into the system, the user interface may display a “home” or default screen. In one embodiment, the default screen that is presented to the pharmacist is the screen for entering the ID number of a potential customer. FIG. 3 is a block diagram representation of an exemplary input screen of the merchant interface 110 for inputting the ID number of a customer. The user interface may require the pharmacist to enter, for example, the type of identification 520, the country, state, county or other entity from which the ID was issued 530, and the ID number 540. Alternatively, the home or default screen may require the entry of different or additional information about the potential customer (e.g., name and/or address). If the merchant interface employs a graphical user interface, any number and combination of text entry boxes, menu choices, check boxes, radio buttons, etc. may be used to input the information. Alternatively, the customer may be asked or required to enter his or her identification information into the interface through a computer terminal, magnetic card reader, etc.

The pharmacist may navigate to the various sections of the merchant user interface by selecting one of the selection tabs 510. In one embodiment, the default or “home” screen may include news, alerts or other information 560 that may be of interest to the pharmacist. For example, a law enforcement officer, healthcare regulator or administrator may have publishing rights on the system and may publish news or bulletins (e.g., reports of stolen products, successful arrests or drug production facility busts).

The information entered at step 220 may be submitted to the database at step 222 by issuing any appropriate command, e.g., by using a mouse to click on a ‘Check’ or ‘Submit’ button 550. At step 224, the database 100 determines if the same ID number has been presented at the same store within a predefined time interval (for example, several minutes, several hours, several days, etc.). If at step 224, the database determines that the same ID was not presented at the same merchant location within the predefined time interval, then at step 230 the user interface 110 receives a response from the database 100 based on the database's evaluation of the submitted information in accordance with pre-set policies and algorithms.

In one scenario, the information received by the interface 10 at step 230 may be a message or indication that there is no record(s) in the database 100 pertaining to the submitted ID number. Such a scenario may occur in at least two possible situations: (1) if the particular ID number has never before been entered into the system prior to this transaction, or (2) if the customer ID has been entered into the system before but the customer's purchase falls within permissible quantity and/or duration limits contained in the database. It is to be understood that the quantity and/or duration limits (which also may be referred to as threshold limits) may be set be statute, a law enforcement or health regulatory agency, or other appropriate entity (such a trade group or association). Threshold limits may be measured and set using any methods of measurement, including volume, weight, time, amount of active ingredient, or combinations thereof as appropriate based on the type of product.

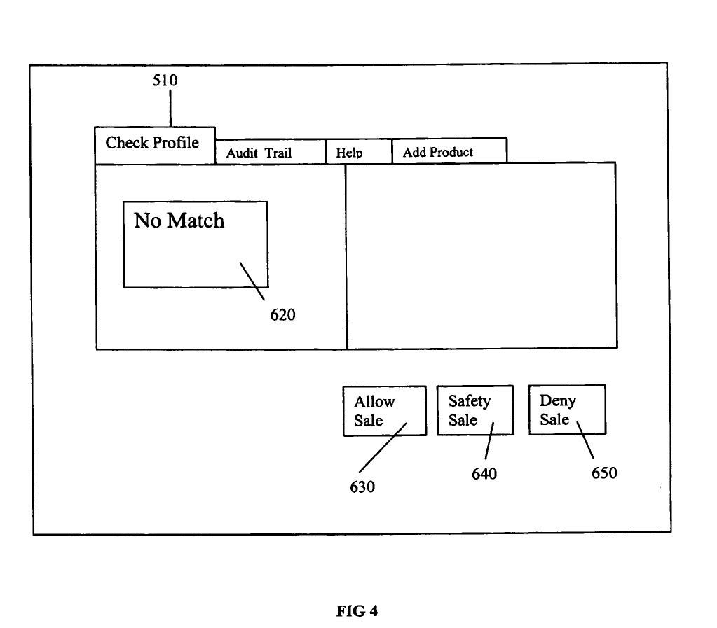

FIG. 4 is a block diagram representation of an exemplary screen that may be displayed on the merchant user interface 110 when a no records message is returned, with the “no match” indication 620 displayed on the screen.

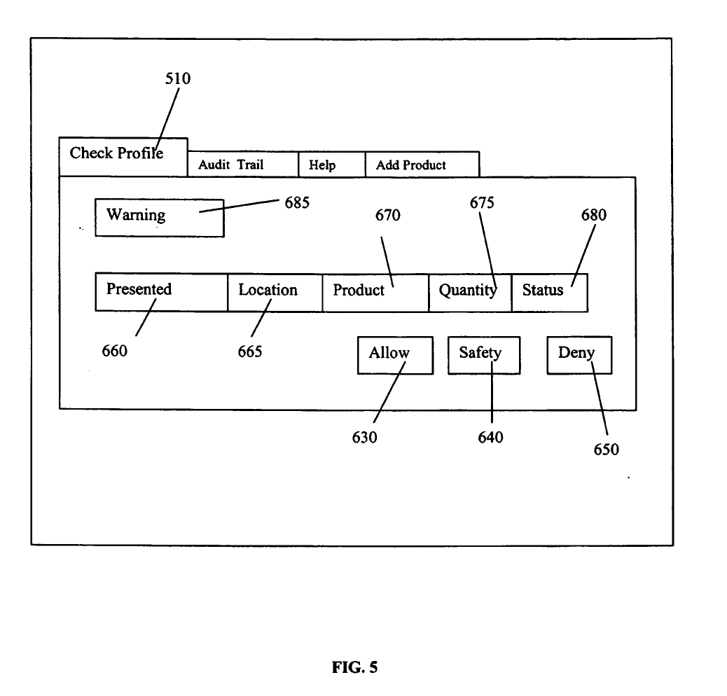

In another scenario, the user interface may receive and display transaction information with respect to the entered ID number. In one embodiment, for example, the user interface may receive and display every (or a subset of every) transaction associated with the entered ID number for a predefined amount of time in the past (e.g., for the last day, last week, etc). The amount of information that is displayed to the pharmacist may be determined based on predefined policies, which may in turn be determined by applicable laws or regulations. In one embodiment, and as shown in FIG. 5, the user interface 110 may receive and display a listing of each sale or potential sale that is associated with this ID for the predefined time period, including the date the ID was presented 660, the location at which the ID was presented 665 (e.g., zip code, city or county), the name of the product 670, the quantity of the product 675 and the status of that transaction 680 (e.g., sale made, sale denied, etc.). The pharmacist or staff member can review this information and make a determination as to whether to make or deny the purchase transaction.

In one embodiment, in addition to the transaction history associated with the ID number, the user interface may receive from the database 100 and display one or more warnings, alerts or notifications 685 with respect to the ID number. For example, the interface may receive and display a warning that multiple pharmacies have recorded different or inconsistent information for this ID number (e.g., different names, genders or addresses) and that, therefore, this is potentially a fake ID. The pharmacist or staff member can also take this additional information into consideration when determining whether to make or deny the purchase transaction.

Having received the response from the database at step 230, in one embodiment the pharmacist or staff member may proceed at step 240 in one of at least three different manners. For example, the pharmacist may decide to make the sale, make a “safety sale,” or deny the sale. The pharmacist may indicate his or her choice to the database by issuing the appropriate command in the user interface for transmittal to the database. In the exemplary user interfaces shown in FIGS. 4 and 5, for example, the pharmacist may indicate his or her choice by selecting the “allow sale” option 630, the “safety sale” option 640 or the “deny sale” option 650. A “safety sale” may be selected if, for example, the pharmacist has a concern about the sale but nevertheless does not want to deny the sale. For example, the pharmacist or staff member may fell threatened or unsafe and may not want to alert the customer to his or her suspicions. The “safety sale” or other similar choice permits the system to record the fact that there was a concern with the sale. This information may be presented to other merchants who are presented with the same ID to let them know that others have had a concern.

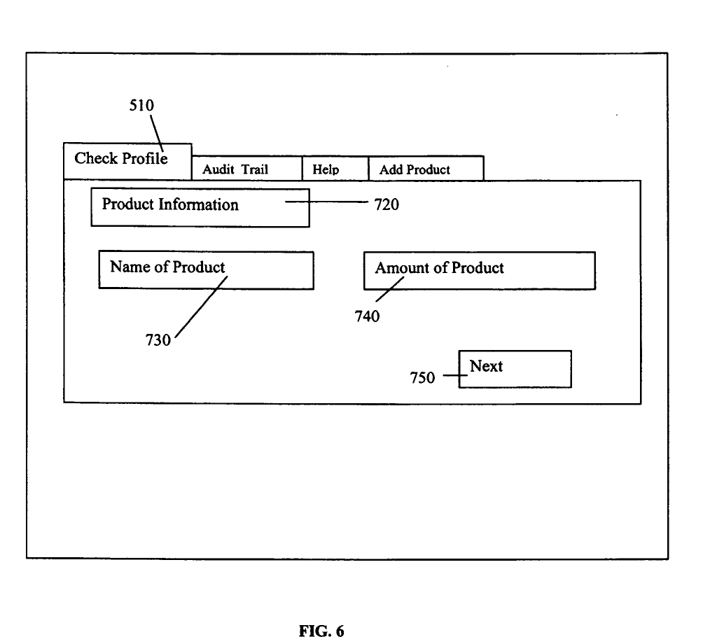

At step 250, the pharmacist may be prompted to enter information pertaining to the product which is the subject of the transaction. The pharmacist may enter the name and quantity of the product or products that the customer intends or intended to buy. FIG. 6 is a block diagram representation of an exemplary screen displayed on the user interface 10 for entering the information with respect to the product(s), including product name 730 and product quantity 740. The information may be inputted into the interface and submitted to the database through the use of any appropriate method including, but not limited to, text entry boxes, menu choices, check boxes, radio buttons, etc. In one embodiment the user interface may include default values for the products and/or quantity, which the pharmacist may accept or change.

At step 260, the system may require the entry of information pertaining to the customer making or attempting to make a purchase of a product. For example, because of applicable statutes or regulations, the system may require that additional information such as the first and last name of the customer, the customer's address, the customers gender, the customer's date of birth, etc. be entered. Additionally, the system itself may associate a time and date stamp with the transaction and customer information, or the time and date information may also be manually entered into the system. An appropriate user interface for entering this information may readily be designed and built by one with ordinary skill in the art using conventional programming techniques and is not otherwise shown in the figures. In one embodiment, the customer as opposed to the pharmacist may be required to directly enter the required information into the user interface 110. In yet another embodiment, the interface may also include appropriate hardware and/or software to capture a record of the customer's signature in connection with the transaction (e.g., a touch pad that can capture an electronic copy or image of the customer's signature).

At step 270, the product and customer information are transmitted to the database 100 for storage and retrieval in accordance with predefined criteria and policies for access to the information. Alternatively, the product information entered at step 250 may be transmitted or submitted to the database 100 separately from (and possibly before) the customer information entered at step 260 is transmitted or submitted to the database 100.

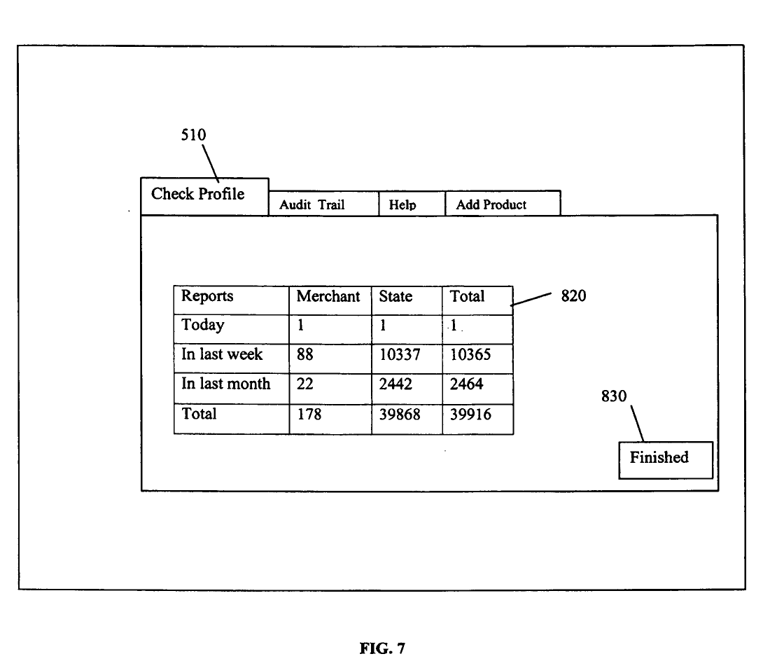

At step 280 the user interface may return to the default or “home” page, provide other information that may be of interest to the pharmacist, or proceed to another section of the user interface. For example, the user interface could present a summary of transactions recorded by the pharmacy, as well as a summary of transactions recorded for a group of pharmacies that meet certain criteria (e.g., all pharmacies in a common geographic location, such as a city or county). FIG. 7 is a block diagram representation of an exemplary embodiment of a user interface display showing a summary of transactions. The merchant may select the “finished” option 830 to return to the home or default screen.

In one embodiment of the method of FIG. 2, if a pharmacist decides to proceed with a sale at step 240, then the system may not require that the pharmacist enter the customer's identification information. In other words, when the pharmacist decides to make a sale, it may not be necessary to perform step 260.

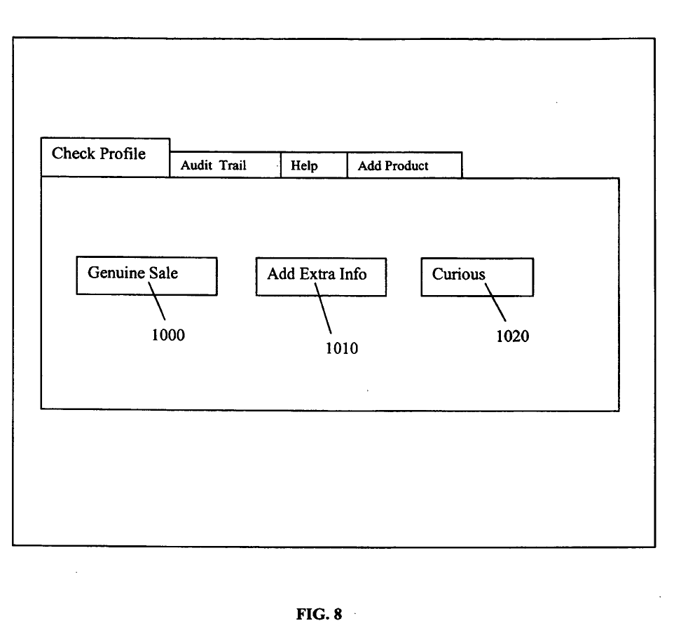

If at step 224, the database determines that the same ID was presented at the same merchant location within the predefined time interval, then at step 290, the user interface may receive and display a request for additional information to determine the reason for such an event occurring. FIG. 8 is a block diagram representation of a an exemplary GUI that may be displayed by the user at step 290. The interface may display one or more choices including, but not limited, to a “genuine sale” option 1000, an “add extra information” option 1010, and a “just curious” option 1020.

At step 300 the pharmacist may choose a reason that the ID is being presented at the same store within the predetermined time interval. For example, the pharmacist may choose the “add extra information” 1010 option when he or she was unable (e.g., was too busy) to enter the customer's pertinent information contemporaneous with the transaction. For example, the pharmacist may have jotted down the information by pen for later entry into the system. If the pharmacist chooses to add extra information, then at step 303 the system proceeds to step 250 to permit the entry of the appropriate information. While in one embodiment the system is designed so that a pharmacist who chooses the “add extra information” option 1010 will be able to add information but not able to delete any information previously entered with respect to a transaction, the system and method of the present disclosure is no so limited. The system and method alternatively could be designed to allow a pharmacist who chooses the “add extra information” option 1010 to add to, delete or otherwise modify the information already in the database with respect to a transaction.

If at step 300 the pharmacist chooses the “genuine sale” option 1000 (i.e., the customer is trying to make another purchase within the predetermined time interval), then at step 302 the system proceeds to step 230 and the system and method continue to operate as previously discussed.

Sometimes pharmacists or other merchants may develop a suspicion or curiosity as to whether a customer who purchased or wanted to purchase a product is in fact a “drug runner” or otherwise engaged in illegal or impermissible conduct. The merchant, therefore, may repeatedly enter the customer's ID number into the system (even though the customer is not present and does not want to make a purchase) in order to ascertain the transactions associated with that ID since the customer left the merchant. This practice, however, potentially could generate spurious data and incorrectly make customers appear to have made multiple requests for product. If the pharmacist selects the “just curious” option 1020, the system may enter into a procedural loop or algorithm that prevents the merchant from obtaining or generating any transaction information associated with the ID number. In one embodiment, for example, if the pharmacists selects the “just curios” option 1020, then at step 301 the system returns to step 230 and the user interface 110 displays a screen (for example of FIG. 3) that may require the pharmacist to enter an ID number.

The merchant user interface 110 may (but need not) also be capable of requesting from the database and displaying for the user records of transactions that have occurred at the merchant. In the exemplary user interface of FIG. 3, for example, the user may select the “audit trail” option 510 to review the transaction history. The user may select to limit the transactions based on different criteria (e.g., limit the transactions to a certain date range or certain ID number). The user interface can query or request the transaction information from the database 100, and display the information (e.g., time, date, name, address, type of ID, ID number, product, quantity, whether sale was made or denied, etc.) for review by the merchant, law enforcement officer, or other authorized person or entity. In one embodiment, the type of information that may be retrieved may be limited or expanded depending on applicable laws or regulations. The merchant may also be able to select one or more of the transactions and add or change the information associated with the transaction.

The merchant user interface 110 may (but need not) include the capability for a merchant to request that a particular product that is not included in the database or monitored by the system be added to the database and be monitored. In the exemplary merchant user interface of FIG. 3, for example, the user may select the “add product” option 510 to navigate to a screen (not shown) to input the information about the product that the user is requesting be added to the database (e.g., name of product, name of active ingredient, amount of active ingredient in the product, etc.). The user interface sends this information to the database which in accordance with predefined policies and/or algorithms either adds the product to the database or generates a message or alert to a law enforcement user, healthcare regulator user or administrator that a merchant has requested that a product be added to the database. The law enforcement user, healthcare regulator user or administrator can review the request and act on it or ignore it as appropriate.

As discussed above, the system may further comprise one or more law enforcement user interfaces 120. The law enforcement user interfaces 120 may be any interface (whether GUI or otherwise) sufficient to allow law enforcement officers and law enforcement agencies to perform their authorized tasks and monitoring. When the law enforcement officer uses his or her unique combination of username and password to gain access to the system, the user interface 120 displays an appropriate user interface to allow the officer to query and review the information contained in the database 100 consistent with the officer's access privileges. In one embodiment of the system (now shown), the law enforcement officer may be able to query and review the information contained in the data base in a number of different ways, including but not limited to: all transactions in a particular time period, all transactions in a certain geographic area, all transactions by product in a particular time period, all transactions at a particular merchant location, all transactions associated with a particular ID, etc. Thus, it is to be understood that a law enforcement officer may use the law enforcement user interface 120 to query and review the information in the database 100 in any manner, subject to the officer's access privilege to the information contained in the database. The law enforcement officer may also be able to export the data contained in the database to one or more files in a range of different formats known to those with skill in the art. This exported file of information may then be interrogated or queried using statistical analysis applications known to and used by law enforcement agencies, regulatory agencies, and those with skill in the art.

In one embodiment, the law enforcement user interface 120 may be implemented using a web-based approach whereby the user interface is a web browser running on a computing device, and the interface accesses the database 100 through the Internet. In such an embodiment, one or more web pages may be provided at the law enforcement user interface 120 which, through the use of menus, text entry boxes, hyper link and the like, allow the law enforcement officer to obtain information from the database. For example, the user interface may provide the capability for the law enforcement officer to obtain information on the most active ID numbers (e.g., those ID numbers presented most often during the purchase of monitored or regulated products), or the most active merchants (e.g., those merchants who engage in the most number of transactions associated with monitored or regulated products). The user interface may also provide the capability to display the information in any rank or format (e.g., the ten most active ID numbers or merchants in a particular zip code displayed in ascending or descending order).

In another embodiment, the data displayed on the law enforcement user interface 120 may be hyperlinked to the extent possible or desirable to allow a law enforcement user to obtain additional information or data associated with a particular piece of information. For example, the law enforcement officer may click on a user ID number which is displayed as part of a listing of all transactions in a given day to view all transactions associated with that ID number. Querying of relational databases through the use of hyperlinks and user interface objects presented on a display are well known to those with ordinary skill in the art, and there is no limitation on the manner in which these programming techniques may be used with the system and methods of the present invention. In another embodiment, the information in the database 100 may be combined with maps to, for example, determine and display on the law enforcement user interface a graphical representation of the movement of a potential “drug runner.” The locations of the pharmacies that a particular ID number has visited can be indicated on the map in sequence, such that the direction of travel can be determined. The maps used by the system may be provided by a third party mapping solution provider or the system may include software and hardware for rendering the maps itself. If provided by a third party, the system and method of the present disclosure may be configured in a manner well known to those with ordinary skill in the art to communicate with the mapping solution provider's system to render the maps and any other information.

A law enforcement officer may also use the law enforcement user interface 120 to obtain from the database 100 all sales transactions associated with a particular pharmacy or merchant in order to review and evaluate the merchant's sales practices and conformance with applicable statutes, regulations or policies. Using this information, the law enforcement officer may be able to determine, for example, that a particular merchant has sold products to a customer using a particular ID number when other merchants had previously refused to sell to a customer with the same ID number. The law enforcement officer may also review and evaluate the merchant's compliance in entering the information required by law, regulation or policy for each transaction. The user interface 120 may also include capabilities for the law enforcement officer to obtain the address and contact information associated with a merchant for appropriate follow-up.

In one embodiment, the law enforcement user interface includes capabilities for setting alerts when predefined conditions are met. For example, through the user interface 120 a law enforcement officer may be able to set an alarm such that an alert is displayed on the user interface and/or sent to a cell phone, PDA, text messaging device or the like when a particular ID number is presented in association with the purchase of a regulated or monitored product. The alert may be sent to any desired group or device. For example, the system may be configured to send the alert to all enforcement officers within a certain geographic area, or within a certain agency, or to a particular person. As another example, the law enforcement officer (or administrator or other person with appropriate access privileges) may enter a stolen ID number into the system and configure the system to alert law enforcement officers when the stolen ID is presented to a merchant.

As previously discussed, the system may also include one or more healthcare regulator user interfaces 130. As with the other user interfaces 110, 120 and 140, the healthcare regulator user interface 130 may be any interface (whether GUI or otherwise) sufficient to allow healthcare regulators to perform their authorized tasks and monitoring. When the healthcare regulator uses his or her unique combination of username and password to gain access to the system, the user interface 130 displays an appropriate user interface (not shown) to allow the regulator to query and review the information contained in the database 100 consistent with the regulator's access privileges. In one embodiment of the system, the healthcare regulator may use the interface 130 to query and review the information contained in the database in a manner similar to the law enforcement officer using the user interface 120, except that applicable laws or regulations may prevent the healthcare regulator from having access to customers' personal identification information.

The healthcare regulator interface 130 (and, if desired or required, the law enforcement officer user interface 120) may also allow a user to access or search a product library that contains, for example, a list of commercially available products to be controlled or monitored using the present system (including, but not limited to, product name, type of active ingredients, amount of active ingredients, manufacturer, etc.). In another embodiment, the user interfaces 120, 130 and/or 140 may include capabilities to allow a user with appropriate access privileges to update or modify which products are monitored or controlled through the system.

As previously mentioned, the system may further comprise one or more administrator interfaces 140. The administrator interface 140 may be any interface (whether GUI or otherwise) sufficient to allow the administrator to perform the requisite administrative tasks. Depending on an administrator's duties and responsibilities, he or she may have different levels of access and privileges with respect to reviewing and modifying the contents of the database 100, the user interfaces 110 through 140, and the operation of the system (for example, setting or modifying alerts, updating contact information for merchants registered with the system or law enforcement agencies, etc).

The types of information that the administrator may enter into the database include, but are not limited to, the access privileges for various users of the system, the products to be monitored, quantity or duration restrictions on the purchase of products to be monitored, cell phone numbers for Short Message Service (SMS) or Text message alerts to various individuals or entities, etc.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

1. A method for monitoring the sale of a product comprising:
acquiring information pertaining to a potential sale of a product by a merchant to a purchaser;
storing the information in a computer storage medium; and
determining whether the potential sale of the product is outside a predefined threshold limit; and
providing to the merchant an indication of whether the potential sale of the product is outside the predefined threshold limit.

2. The method of claim 1, wherein the product is a regulated product.

3. The method of claim 2, wherein the regulated product is an over-the-counter pharmaceutical product and the merchant is a pharmacist.

4. The method of claim 1, wherein the information is stored in a relational database.

5. The method of claim 1, wherein the information pertaining to the potential sale is comprised of information selected from the group consisting of a name of the purchaser, an identification number of the purchaser, an amount of the product to be purchased, a date of the purchase, a time of the purchase, a location of the merchant, and a signature of the purchaser.

6. The method of claim 1, wherein the step of providing is further comprised of displaying on a user interface information that the merchant can view and evaluate to determine whether the potential sale of the product is outside the predefined threshold limit.

7. The method of claim 1, wherein the indication is a message that there are no records pertaining to the purchaser.

8. A method for monitoring sale of a product comprising:
receiving information pertaining to a potential sale of a product by a merchant to a customer;
evaluating the information in view of a predefined policy relating to the sale of the product; and
providing to the merchant an indication of whether the potential sale of the product conforms to the predefined policy.

9. The method of claim 8 further comprising: storing the information in a computer-readable storage medium.

10. The method of claim 9 further comprising: tracking an amount of the product sold to the customer.

11. The method of claim 9, wherein the information is stored in a database.

12. The method of claim 11, wherein the database is a relational database.

13. The method of claim 8, wherein the information pertaining to the potential sale of the product is comprised of an identification number of the customer.

14. The method of claim 8, wherein the information pertaining to the potential sale of the product is comprised of information selected from the group consisting of a name of the customer, an identification number of the customer, an amount of the product to be purchased, a date of the purchase, a time of the purchase, a location of the merchant, and a signature of the customer.

15. The method of claim 8, wherein the step of evaluating is further comprised of:
reviewing previous sales of the product to the customer, and determining whether the potential sale of the product falls within predefined quantity and duration limitations on the sale of the product.

16. The method of claim 8, wherein the indication is a message that there are no records pertaining to the customer.

17. The method of claim 8, wherein the indication is a message that the potential sale is contrary to the predefined policy.

18. The method of claim 8, wherein the step of providing is comprised of displaying on a user interface information that the merchant can view and evaluate to determine whether the potential sale of the product conforms to the predefined policy.

19. The method of claim 8, wherein the product is a regulated product.

20. The method of claim 19, wherein the regulated product is a pharmaceutical product and the merchant is a pharmacist.

21. The method of claim 19, where in the regulated product is an over-the-counter pharmaceutical product.

22. The method of claim 21, wherein the over-the-counter pharmaceutical product is a product that contains pseudoephedrine as an active ingredient.

23. The method of claim 8, wherein the indication is comprised of at least one prior transaction information pertaining to the customer.

24. The method of claim 23, wherein the at least one prior transaction information is selected from the group consisting of a date of the prior transaction, a location of the prior transaction, a name of the product, a quantity of the product, and a status of the prior transaction.

25. An article of manufacture comprising a program storage medium readable by a computer and embodying one or more instructions executable by the computer for performing the method of monitoring sale of a product, comprising:
receiving information pertaining to a potential sale of a product by a merchant to a customer;
evaluating the information in view of a predefined policy relating to the sale of the product; and
providing to the merchant an indication of whether the potential sale of the product conforms to the predefined policy.

26. A method of monitoring sale of a product comprising:
collecting information pertaining to a potential sale of a product by a merchant to a customer;
submitting the information for evaluation in view of a predefined policy relating to the sale of the product; and
receiving an indication of whether the potential sale of the product conforms to the predefined policy.

27. The method of claim 26 further comprising: deciding whether to sell the product to the customer.

28. The method of claim 26, wherein collecting the information further comprises the customer providing to the merchant at least one identification information.

29. The method of claim 28, where the identification information is comprised of information selected from the group consisting of a name of the customer, an identification number of the customer, an amount of the product to be purchased, a date of the purchase, a time of the purchase, and a signature of the customer.

30. The method of claim 26, wherein collecting the information further comprises determining a name and a quantity of the product.

31. The method of claim 26, wherein submitting the information is comprised of submitting a subset of the information collected pertaining to the potential sale of the product.

32. The method of claim 26, wherein the product is a regulated product.

33. The method of claim 32, wherein the regulated product is a pharmaceutical product and the merchant is a pharmacist.

34. The method of claim 32, where in the regulated product is an over-the-counter pharmaceutical product.

35. The method of claim 34, wherein the over-the-counter pharmaceutical product is a product that contains pseudoephedrine as an active ingredient.

36. The method of claim 26, wherein the indication is comprised of at least one prior transaction information pertaining to the customer.

37. The method of claim 36, wherein the at least one prior transaction information is selected from the group consisting of a date of the prior transaction, a location of the prior transaction, a name of the product, a quantity of the product, and a status of the prior transaction.

38. A method for notifying an entity whether a customer is attempting to purchase a product in excess of a predetermined limit, the method comprising:
receiving at least one datum pertaining to an attempted purchase transaction by a customer from a merchant;
determining whether the attempted purchase transaction conforms to a predetermined limit on the purchase of the product; and
notifying the entity whether the attempted purchase conforms to the predetermined limit.

39. The method of claim 38, wherein the step of determining is comprised of evaluating the at least one datum against information stored in a database, wherein the information stored in the database is comprised of the predetermined limit on the purchase of the product and at least one record indicative of whether the customer has previously purchased the product.

40. The method of claim 39, wherein the at least one datum is comprised of information identifying the customer, and wherein the step of evaluating is comprised of comparing the at least one datum and the predetermined limit on the purchase of the product against the at least one record indicative of whether the customer has previously purchased the product.

41. The method of claim 39, wherein the entity is the merchant.

42. The method of claim 39, wherein the entity is a law enforcement agent.

43. The method of claim 39 further comprising: configuring the database to generate an alert when at least one predefined condition is met.

44. The method of claim 43, wherein the at least one predefined condition is that the customer who is attempting the purchase has a predefined identification number.

45. The method of claim 39, wherein the predetermined limit is established by law.

46. A method of accessing a database to obtain information to monitor a sale of a regulated product comprising:
accessing a database through a user interface, wherein contents of the database are comprised of information identifying at least one regulated product, information identifying at least one merchant who sells the product; sales transaction records of the at least one regulated product; and information identifying at least one customer who has purchased the regulated product;
using the user interface to implement a search of the contents of the database with respect to the sale of the at least one regulated product; and
receiving a result of the search through the user interface.

47. The method of claim 46, wherein the information identifying the at least one regulated product is comprised of a name of the regulated product, and a quantity and a duration limitation placed on a sale of the regulated product; the information identifying the at least one merchant is comprised of a name of the merchant, a location of the merchant, and a contact information of the merchant; the sales transaction records are comprised of records of a name of the regulated product, a quantity of the regulated product, a time the regulated product was sold and an identification number of a customer to whom the regulated product was sold; and the information identifying the at least one customer is comprised of a name of the customer and the identification number of the customer.

48. The method of claim 46, wherein the search of the contents of the database is comprised of searching the contents of the database to identify at least one transaction by a specific customer.

49. The method of claim 46, wherein the search of the contents of the database is comprised of searching the contents of the database to identify at lest one transaction by a specific merchant.

50. The method of claim 46, wherein the search of the contents of the database is comprised of searching the contents of the database to identify at least one transaction pertaining to a specific product.

51. The method of claim 46, wherein the search of the contents of the database is comprised of searching the contents of the database to identify at least one merchant who has sold a specific product.

52. The method of claim 46, wherein the search of the contents of the database is comprised of searching the contents of the database to identify products sold by a specific merchant.

53. The method of claim 46, wherein the search of the contents of the database is comprised of searching the contents of the database to identify products purchased by a specific customer.

54. The method of claim 46, wherein the search of the contents of the database is comprised of searching the contents of the database to identify customers who have purchased a specific product.

55. A computer database for monitoring sale of a regulated product, the database comprising: at least one regulated product; at least one predetermined limitation on the sale of the regulated product, identification information of customers who purchase the regulated product, and historical regulated product purchase information for each customer who purchased the regulated product.

56. The computer database of claim 55, wherein the at least on regulated product is comprised of a name of the product, a quantity of the product and an active ingredient of the product.

57. The computer database of claim 55, wherein the at least one predetermined limitation on the sale of the regulated product is comprised of a predetermined quantity limitation and a predetermined duration limitation on the sale of the regulated product.

58. The computer database of claim 55, wherein the identification information of customers who purchase the regulated product is comprised of a government issued identification number.

59. The computer database of claim 58, wherein the identification information of customers who purchase the regulated product is further comprised of a name of the customer.

60. The computer database of claim 59, wherein the identification information of customers who purchase the regulated product is further comprised of a signature of the customer.

61. The computer database of claim 55 further comprising: access privilege information for a user that can access and communicate with the database.

62. The computer database of claim 55, wherein the historical regulated product purchase information for each customer who purchased the regulated product is comprised of a name of the product purchased, a quantity of the product purchased, a time that the product was purchased, and a location that the product was purchased.
